(19) United States
(12) Patent Application Publication
(10) Pub. No.: US 2003/0189981 A1
(43) Pub. Date: Oct. 9, 2003

(54) Method and apparatus for determining motion vector using predictive techniques

(75) Inventor: Jun-Ho Lee, Anyang (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/408,098

(22) Filed: Apr. 8, 2003

(30) Foreign Application Priority Data
Apr. 8, 2002 (KR) 19020/2002

(51) Int. Cl. H04B 1/66

(52) U.S. Cl. 375/240.16

(57) ABSTRACT

A method and apparatus for determining a motion vector in coding a moving picture, including determining a searching point having a minimum sum of absolute difference (SAD). A first predictive motion vector is determined by performing a N search on the basis of a predetermined pixel, determining a searching point having a minimum SAD as a second predictive motion vector by performing a

$$\frac{N}{{2}^{n}}$$

search on the basis of a predetermined pixel and determining a motion vector by comparing the first predictive motion vector and second predictive motion vector. This improves definition quality of moving pictures, since the motion vector can be determined rapidly and precisely.

### BACKGROUND OF THE INVENTION

1. Field of the Invention

The present invention relates to a method for determining a motion vector and more particularly, to a method for determining a motion vector, using predictive techniques.

2. Background of the Related Art

Recently, as interest on moving picture encoding increases, various standards relating to moving pictures are established. These standards are applied to various fields, such as visual telephones, digital broadcasting, high definition TVs and digital cameras.

A motion vector is information that indicates direction among frames of a point displayed on a screen in coding of the moving picture. Detection of the motion vector helps reduce duplication of time among frames, and it positively affects the definition quality of the image and compression speed.

Generally, the motion vector is determined by finding out a position of a block which is the closest block in the former frame on the basis of a macro block which is in predetermined coordinates of the current frame. A part which is out of line between two sheets of frames which are temporally close is called as a search range, and the search range is positioned in the former frame.

A method is used to determine the motion vector by finding out the position of the closest block with the macro block of the current frame, a position corresponding to a value having the smallest sum after summing all of the absolute values by obtaining the difference of the pixels forming the pixel in the search range of the former frame and the pixels of the macro block of the current frame. The sum of the absolute values after obtaining the difference between the former frame and current frame is a sum of absolute difference (SAD). In the case where the datum point of the macro block is (x, y) and the datum point of a block which is closest from the macro block in the search range of the former frame is (x+u, Y+v), the motion vector is determined as (u, v).

Full search and a three step search are two methods for determining the motion vector. Full search is the most basic method among the methods for searching the macro block corresponding to the macro block of the current frame in the former frame. Because the operations of subtraction, yielding and summing of absolute values must be performed for the respective pixels of all search ranges, an optimal motion vector can be found, but this requires too much calculation and also decreases the processing speed.

The three step search is a type of searching algorithm which can predict the motion vector at high speed by reducing the number of the searching points. After obtaining searching points which related the most among the 9 apart searching points, the interval among the searching points is reduced to the half by moving to the searching point. The above process is repeated three additional times, in order to determine the motion vector.

The three step search method requires small amounts of calculation and fast speed, but the precision of the motion vector obtained is low this degrades the definition quality of the decoded image through the encoder.

### SUMMARY OF THE INVENTION

An object of the present invention is to provide a method for determining a motion vector, capable of yielding the motion vector with a precision which is close to the full search, but using less calculation.

To achieve these and other advantages and in accordance with the purpose of the present invention, as embodied and broadly described herein, the first characteristic of the method for determining a motion vector is that the method includes the steps of determining a searching point having a minimum sum of absolute difference (SAD) as a first predictive motion vector by performing a N search on the basis of a predetermined pixel, determining a searching point having a minimum SAD as a second predictive motion vector by performing a

$$\frac{N}{{2}^{n}}$$

search on the basis of a predetermined pixel and determining a motion vector by comparing the first predictive motion vector and second predictive motion vectors.

To achieve these and other advantages and in accordance with the purpose of the present invention, as embodied and broadly described herein, the second characteristic of the method for determining a motion vector is that the method includes the steps of determining a searching point having a minimum SAD as the first predictive motion vector by performing a N search on the basis of a predetermining pixel, determining whether the first predictive motion vector is (0, 0), obtaining a searching point having a minimum SAD by performing a

$$\frac{N}{{2}^{n}}$$

search on the basis of a predetermined pixel if the first predictive motion vector is not (0, 0), determining whether a distance between the searching point having the minimum SAD and (0, 0) is 1 pixel, determining a searching point having a minimum SAD as the second predictive motion vector by performing a M search on the basis of the minimum SAD if the distance is not 1 pixel and determining the final motion vector by comparing the first and second predictive motion vectors.

To achieve these and other advantages and in accordance with the purpose of the present invention, as embodied and broadly described herein, the third characteristic of the method for determining a motion vector is that the method includes the steps of determining a searching point having a minimum SAD as a first predictive motion vector by performing a N search on the basis of a predetermining pixel between a current frame and a former frame, determining the first predictive motion vector as the final motion vector if the first motion vector is (0, 0), determining a minimum SAD among SADs by obtaining the respective 9 SADs by N/2 pixel search, N/4 pixel search, . . . , 1 pixel search on the basis of a predetermined pixel if the first motion vector is not (0, 0), determining a second predictive motion vector by M/2 search in case the minimum SAD is a minimum SAD obtained by a M pixel search (M≠1) and determining a searching point having a smaller SAD between the searching points corresponding to the first and second predictive motion vectors as the final motion vector.

To achieve these and other advantages and in accordance with the purpose of the present invention, as embodied and broadly described herein an apparatus for determining a motion vector, comprising the means for determining a searching point having a minimum sum of absolute difference (SAD) as a first predictive motion vector by performing a N search on the basis of a predetermined pixel. A means for determining a searching point having a minimum sum of absolute difference as a second predictive motion vector by performing a

$$\frac{N}{{2}^{n}}$$

search on the basis of a predetermined pixel and a means for determining a motion vector by comparing the first predictive motion vector and the second predictive motion vector.

The foregoing and other objects, features, aspects and advantages of the present invention will become more apparent from the following detailed description of the present invention when taken in conjunction with the accompanying drawings.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

### IN THE DRAWINGS

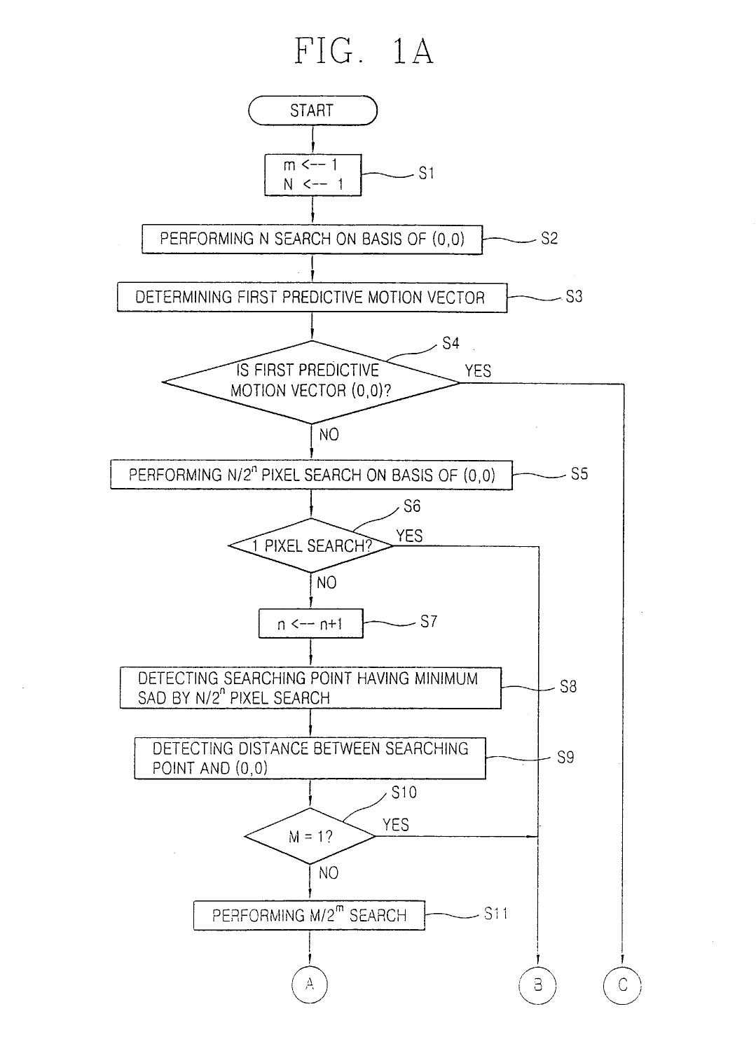

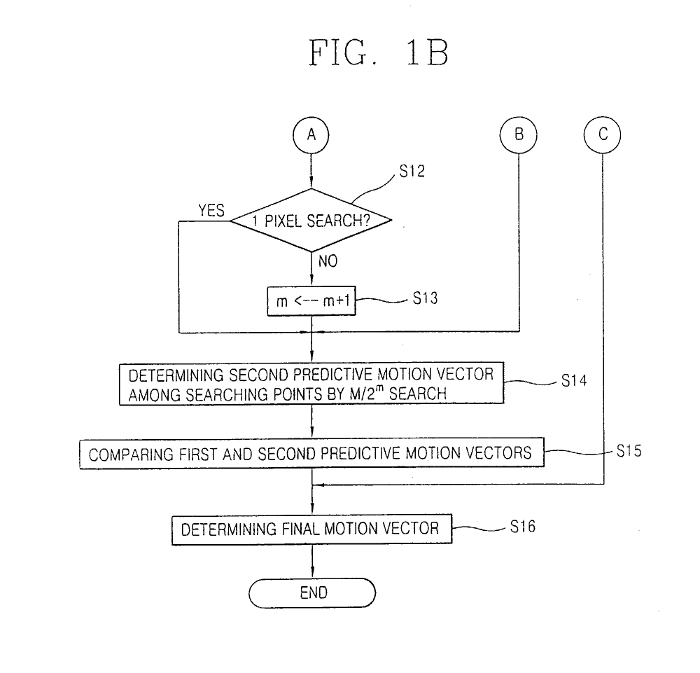

FIGS. 1A and 1B are flow charts illustrating an exemplary method for determining the motion vector in accordance with one embodiment of the present invention; and

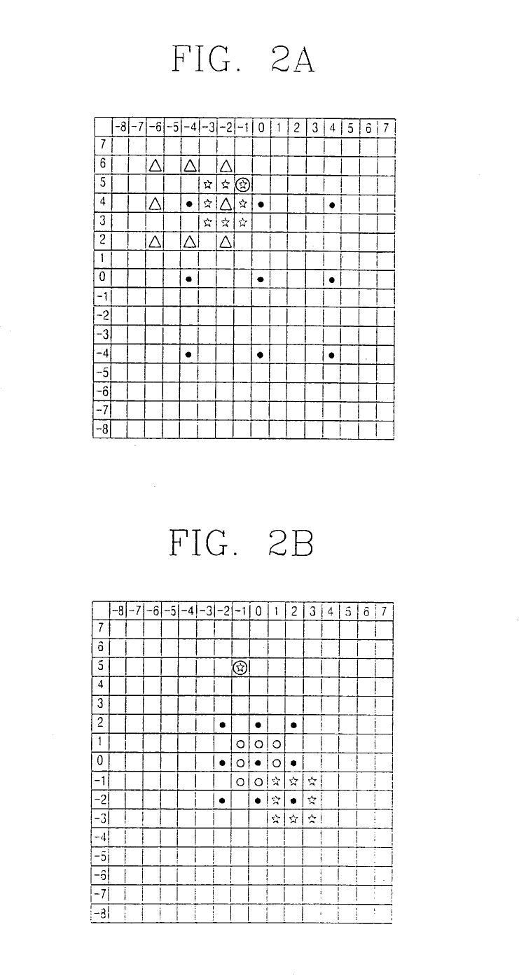

FIGS. 2A and 2B are views showing exemplary embodiments of the method for determining the motion vector in accordance with various embodiments of the present invention.

### DETAILED DESCRIPTION OF PREFERRED EMBODIMENTS

Reference will now be made in detail to the preferred embodiments of the present invention, examples of which are illustrated in the accompanying drawings.

In one exemplary scenario, there is a high probability that the motion vector is close to (0, 0), and upon obtaining a sum of absolute difference (hereinafter, as SAD), there is not much difference between a method of searching the motion vector by using 16×16 pixels in a macro block and a method of searching the motion vector by using 16×8 pixels. Therefore, the method for determining a motion vector in accordance with the claimed invention uses the above characteristic of the motion vector.

FIGS. 1A and 1B are flow charts illustrating an exemplary method for determining the motion vector in accordance with one embodiment of the present invention. As shown in FIGS. 1A and 1B, a searching point having a minimum SAD is determined as a first predictive motion vector by performing a N search on the basis of (0, 0) and whether the first predictive motion vector is (0, 0) is determined (S1 to S4).

In the N search, SADs corresponding to 9 searching points are obtained at a N pixel interval, and SADs of searching points which are positioned at a half distance of an initial pixel interval on the basis of a searching point having a minimum value among the SADs are obtained. The process of obtaining the SAD of the searching point is performed repeatedly until the distance among the searching points becomes 1 pixel. After finding out the searching point having a minimum SAD, this searching point is determined to be the final motion vector.

For example, an 8 search obtains the SAD while moving the searching points at an 8 pixel interval on the basis of (0, 0). The respective SADs of the 9 searching points including (0, 0) are outputted. Among the 9 SADs, SADs corresponding to the 9 searching points at a 4 pixel interval on the basis of the searching point having the smallest SAD are obtained. Also, SADs corresponding to the 9 searching points at a 2 pixel interval on the basis of the searching point having the smallest SAD among the SADs of the searching points are obtained. SADs corresponding to the 9 searching points at an 1 pixel interval on the basis of the searching point having the smallest SAD are obtained again. At this time, a searching point having the minimum SAD is determined to be the motion vector among the searching points.

If it is determined that the motion vector of the searching point is not (0, 0), the SADs corresponding to the searching points positioned at a N/2 pixel which is half of the initial interval are obtained (S5), and it is determined whether the N/2 pixel is 1 pixel (S6). If it is determined that the N/2 is not 1 pixel, respective SADs corresponding to searching points positioned at a

$$\frac{N}{{2}^{n}}$$

pixel interval are obtained until N/2 becomes 1 pixel, and a searching point having the minimum SAD is detected among the searching points (S7 and S8).

That is, the searching point having the minimum SAD is detected by performing a

$$\frac{N}{2}$$

pixel search, a

$$\frac{N}{4}$$

pixel search, a

$$\frac{N}{8}$$

pixel search, . . . , a 1 pixel search, and the N pixel search is performed by obtaining SADs of 9 searching points including itself in a random position in a 2 dimensional image.

By detecting a pixel M of a distance between a searching having the minimum SAD and (0, 0) (S9), after determining whether the distance is 1 pixel (S10), respective SADs corresponding to searching points positioned at a

$$\frac{M}{{2}^{m}}$$

pixel interval on the basis of the searching point having the minimum SAD are obtained if the distance is not 1 pixel (S13).

At this time, by determining whether the

$$\frac{M}{{2}^{m}}$$

becomes 1 (S12), the respective SADs of the respective searching points are obtained while increasing m until the value of the

$$\frac{M}{{2}^{m}}$$

reaches to 1.

When the

$$\frac{M}{{2}^{m}}$$

becomes 1, a searching point having the minimum SAD among respective searching points obtained in the above process on the basis of the searching point having the minimum SAD is outputted, and this searching point is determined as the second predictive motion vector (S14). By comparing the first predictive motion vector and second predictive motion vector (S15), a motion vector having a smaller SAD is determined as the final motion vector (S16).

FIGS. 2A and 2B are views showing exemplary embodiments of the method for determining a motion vector in accordance with various embodiments of the present invention. An exemplary search range from −8 to 7 (16×16) pixels will now be described.

Firstly, respective SADs of the 9 searching points including (0, 0) positioned at a 4 pixel interval on the basis of (0, 0) are obtained, and the respective SADs of the 9 searching points positioned at a 2 pixel interval on the basis of the searching point having the minimum SAD are obtained. SADs of 9 close searching points positioned at a 1 pixel interval on the basis of the searching point having the minimum SAD among the searching points positioned at a 2 pixel interval are obtained, and a searching point having the minimum SAD among the searching points is determined as the first predictive motion vector.

If the first predictive motion vector is (0, 0), the first predictive motion vector is determined as the final motion vector and the overall processes are ended. However, if it is presumed that the first predictive motion vector is not (0, 0) and the motion vector is 4 pixels apart from (0, 0), respective SADs of 9 searching points which are positioned at a 2 pixel interval on the basis of (0, 0) and 9 searching points which are positioned at a 1 pixel interval are obtained. After finding out a searching point having a minimum SAD among the 18 searching points including duplicated positions, the searching point having a minimum SAD which is selected from the 9 pixels positioned at a 1 pixel interval including the searching point having the minimum SAD is determined as the second predictive motion vector, if the searching point having the minimum SAD is 2 pixels apart from (0, 0).

The searching point having a smaller SAD between the first and second predictive motion vectors is determined as the final motion vector. As the method for determining the motion vector in accordance with the present invention, an example of 16×16 pixels is described, but it is not limited by the example and can be applied to 32×32 pixels or more pixels. As described above, since a motion vector of precision which is close to a full search can be obtained by a small amount of calculation, definition quality of the image can be improved. Also, the present invention can prevent degradation of precision caused by the initial selection of a wrong searching point, as the final motion vector is determined by comparing a plurality of predictive motion vectors.

In another embodiment of the present invention, an apparatus for determining a motion vector includes a means for determining a search point having a minimum sum of absolute difference (SAD) as a first predictive motion vector by performing a N search on the basis of a predetermined pixel.

Additionally, a means for determining a searching point having a minimum sum of absolute difference as a second predictive motion vector by performing a

$$\frac{N}{{2}^{n}}$$

search on the basis of a predetermined pixel. There is also a means for determining a motion vector by comparing the first predictive motion vector and the second predictive motion vector.

These various determining means may be implemented in various exemplary embodiments. For example, a single processor may be used to execute the processing algorithm, or a plurality of processors may be used to decentralize processing operations. In another example, the algorithms may reside on firmware or other programmable and executable media.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for determining a motion vector, comprising:
determining a searching point having a minimum sum of absolute difference (SAD) as a first predictive motion vector by performing a N search on the basis of a predetermined pixel;
determining a searching point having a minimum sum of absolute difference as a second predictive motion vector by performing a
$$\frac{N}{{2}^{n}}$$
search on the basis of a predetermined pixel; and
determining a motion vector by comparing the first predictive motion vector and the second predictive motion vector.

2. The method of claim 1, wherein determining the first predictive motion vector includes:
obtaining the searching point having the minimum SAD among searching points at a N pixel interval on the basis of (0, 0);
obtaining a searching points having a minimum SAD among searching points positioned at a N/2 pixel interval on the basis of the searching point having the minimum SAD;
determining whether the distance between the searching point having the minimum SAD and the center is 1 pixel; and
determining the searching point having the minimum SAD as the first predictive motion vector if the distance is 1 pixel.

3. The method of claim 2, wherein the distance is reduced until the distance reaches to 1 pixel, and obtaining the searching point having the minimum SAD is repeatedly performed if the distance is not 1 pixel.

4. The method of claim 1, wherein determining the second predictive motion vector includes:
obtaining a searching point having a minimum SAD among searching points positioned at a N/2 pixel interval on the basis of (0, 0),
determining whether the distance between the searching point having the minimum SAD and the (0, 0) is 1 pixel; and
determining the searching point having the minimum SAD as the second predictive motion vector if the distance is 1 pixel.

5. The method of claim 4, wherein if the distance is not 1 pixel, determining the second predictive motion vector includes:
obtaining a searching point having the minimum SAD among searching points positioned at M/2 pixel interval on the basis of the searching point having the minimum SAD;
determining whether a distance between the searching point having the minimum SAD and the center is 1 pixel; and
determining the searching point having the minimum SAD as the second predictive motion vector if the distance is 1 pixel.

6. The method of claim 5, wherein the distance is reduced until the distance reaches to 1 pixel, and obtaining the searching point having the minimum SAD is repeatedly performed if the distance is not 1 pixel.

7. The method of claim 1, wherein determining the final motion vector includes:
comparing SADs of respective searching points corresponding to the first and second predictive motion vectors; and
determining a motion vector corresponding to a searching point having a smaller SAD as a final motion vector.

8. A method for determining a motion vector, comprising:
determining a searching point having a minimum SAD as the first predictive motion vector by performing a N search on the basis of a predetermining pixel;
determining whether the first predictive motion vector is (0, 0);
obtaining a searching point having a minimum SAD by performing a
$$\frac{N}{{2}^{n}}$$
search on the basis of a predetermined pixel if the first predictive motion vector is not (0, 0);
determining whether a distance between the searching point having the minimum SAD and (0, 0) is 1 pixel;
determining a searching point having a minimum SAD as the second predictive motion vector by performing a M search on the basis of the minimum SAD if the distance is not 1 pixel; and
determining the final motion vector by comparing the first and second predictive motion vectors.

9. The method of claim 8, wherein determining the second predictive motion vector includes:
obtaining a searching point having a minimum SAD among searching points positioned at a N pixel interval on the basis of (0, 0),
obtaining a searching point having a minimum SAD among searching points positioned at a N/2 pixel interval on the basis of the searching point having the minimum SAD;
determining whether the distance between the searching point having the minimum SAD and the center is 1 pixel; and
determining the searching point having the minimum SAD as the first predictive motion vector if the distance is 1 pixel.

10. The method of claim 9, wherein the distance is reduced until the distance reaches to 1 pixel, and obtaining the searching point having the minimum SAD is repeatedly performed if the distance is not 1 pixel.

11. The method of claim 8, further comprising:
determining the first motion vector as the final motion vector if the first motion vector is (0, 0).

12. The method of claim 8, further comprising:
determining the searching point having the minimum SAD as the second motion vector if the distance between the searching point having the minimum SAD and the (0, 0) is 1 pixel.

13. The method of claim 8, wherein a searching point having a smaller SAD is determined as the final motion vector among searching points corresponding to the first and second predictive motion vectors in determining the final motion vector.

14. The method of claim 8, wherein the searching points having the predetermined pixel at the center are 9 searching points including the center.

15. A method for determining a motion vector, comprising:
determining a searching point having a minimum SAD as a first predictive motion vector by performing a N search on the basis of a predetermining pixel between a current frame and a former frame;
determining the first predictive motion vector as the final motion vector if the first motion vector is (0, 0);
determining a minimum SAD among SADs by obtaining the respective 9 SADs by N/2 pixel search, N/4 pixel search, . . . , 1 pixel search on the basis of a predetermined pixel if the first motion vector is not (0, 0);
determining a second predictive motion vector by M/2 search in case the minimum SAD is a minimum SAD obtained by a M pixel search (M≠1) and
determining a searching point having a smaller SAD between the searching points corresponding to the first and second predictive motion vectors as the final motion vector.

16. A method for determining a motion vector, comprising:
determining a first searching point using information obtained from a former frame and a current frame and establishing said first searching point as a first predictive motion vector by performing a first search on the basis of predetermined pixel;
determining a second searching point using information obtained from a former frame and a current frame and establishing said second searching point as a second predictive motion vector by performing a second search on the basis of a predetermined pixel; and
determining a motion vector by comparing the first predictive motion vector and the second predictive motion vector.

17. The method of claim 16, wherein the first searching point is determined having a minimum sum of absolute difference (SAD) as the first predictive motion vector by performing a N search on the basis of a predetermined pixel.

18. The method of claim 16, wherein the second searching point is determined having a minimum sum of absolute difference (SAD) as the second predictive motion vector by performing a
$$\frac{N}{{2}^{n}}$$
search on the basis of a predetermined pixel

19. An apparatus for determining a motion vector, comprising:
a means for determining a searching point having a minimum sum of absolute difference (SAD) as a first predictive motion vector by performing a N search on the basis of a predetermined pixel;
a means for determining a searching point having a minimum sum of absolute difference as a second predictive motion vector by performing
$$\frac{N}{{2}^{n}}$$
search on the basis of a predetermined pixel; and
a means for determining a motion vector by comparing the first predictive motion vector and the second predictive motion vector.
